(19) United States
(12) Patent Application Publication
(10) Pub. No.: US 2020/0189253 A1
(43) Pub. Date: Jun. 18, 2020

(54) LAMINATED FOAM SHEET AND MOLDED ARTICLE THEREOF

(71) Applicant: SEKISUI PLASTICS CO., LTD., Osaka (JP)

(72) Inventors: Hiroaki KITADE, Koga-shi (JP); Tadakazu ANAN, Satte-shi (JP); Kouji UEDA, Koga-shi (JP); Yosuke KAWAMORITA, Koga-shi (JP)

(73) Assignee: SEKISUI PLASTICS CO., LTD., Osaka (JP)

(21) Appl. No.: 16/640,972

(22) PCT Filed: Sep. 25, 2018
(86) PCT No.: PCT/JP2018/035360

§ 371 Date: Feb. 21, 2020

(30) Foreign Application Priority Data
Oct. 16, 2017 (JP) 2017-200299

(51) Int. Cl. B32B 27/32; B32B 5/18; B65D 65/40; C08J 9/36; C08J 9/04

(52) U.S. Cl. CPC B32B 27/32; B32B 5/18; C08J 9/04; C08J 9/36; B65D 65/40

(57) ABSTRACT

The present invention relates to a laminated foam sheet including a foam layer and a non-foam layer positioned on one surface or both surfaces of the foam layer, in which a closed cell ratio of the foam layer is 70% or more and a thickness is 2.0 to 6.0 mm, and the non-foam layer includes a non-crosslinked olefin-based elastomer.

### TECHNICAL FIELD

The present invention relates to a laminated foam sheet and a molded article thereof.

Priority is claimed on Japanese Patent Application No. 2017-200299 filed on Oct. 16, 2017, the content of which is incorporated herein by reference.

### BACKGROUND ART

In the related art, there is known a laminated foam sheet provided with a foam layer using a thermoplastic resin as a base material resin and a non-foam layer using a thermoplastic resin as a base material resin. Since such a laminated foam sheet is excellent in heat resistance and light weight, the laminated foam sheet is used as a raw material for food packaging containers and the like.

In addition, in vehicle applications, there is a demand for lightweight products for anti-slip applications such as floor mats and luggage trays.

There is a demand for food packaging containers and the like to have slip-resistant properties (a grip property) when placed on a table.

PTL 1 proposes a foam laminate having a foam layer and an adhesive layer containing a synthetic rubber. In addition, PTL 2 proposes a laminated foam sheet having a foam body layer and a thermoplastic elastomer layer. According to the foam laminates of PTLs 1 and 2, it is possible to realize a grip property.

### CITATION LIST

### Patent Literature

[PTL 1] Japanese Unexamined Patent Application, First Publication No. 2014-180818

[PTL 2] Japanese Unexamined Patent Application, First Publication No. 2009-184181

### DISCLOSURE OF INVENTION

### Technical Problem

However, the foam laminates of PTLs 1 and 2 have a problem in that the layers are easily peeled off during thermoforming.

In addition, there is a demand for the laminated foam sheet to have elongation which is able to follow a molded shape during molding and strength when formed into a molded article.

The present invention was made in view of the above circumstances and has an object of providing a laminated foam sheet having a slip-resistant surface, excellent strength, and excellent thermoformability, and a molded article thereof.

### Solution to Problem

As a result of intensive studies, the present inventors found that it is possible to solve the problems described above by using a laminated foam sheet in which a foam layer and a non-foam layer including a non-crosslinked olefin-based elastomer are laminated.

The present invention has the following aspects.

[1] A laminated foam sheet including a foam layer; and a non-foam layer positioned on one surface or both surfaces of the foam layer, in which a closed cell ratio of the foam layer is 70% or more and a thickness is 2.0 to 6.0 mm, and the non-foam layer includes a non-crosslinked olefin-based elastomer.
[2] The laminated foam sheet according to [1], in which the non-foam layer has a Duro A hardness of 70 or less as determined in accordance with JIS K6253-3.
[3] The laminated foam sheet according to [1] or [2], in which a fracture point elongation percentage of the non-foam layer determined in accordance with JIS K6251 is 900% or more.
[4] The laminated foam sheet according to any one of [1] to [3], in which the non-foam layer has a thickness of 0.1 to 0.3 mm.
[5] The laminated foam sheet according to any one of [1] to [4], having a density of 100 to 400 Kg/m³.
[6] The laminated foam sheet according to any one of [1] to [5], in which a bending strength determined in accordance with JIS K7171 is 6.0 MPa or less.
[7] The laminated foam sheet according to any one of [1] to [6], in which a maximum displacement determined in accordance with JIS K7171 is 10 mm or more.
[8] The laminated foam sheet according to any one of [1] to [7], in which a maximum static friction coefficient determined in accordance with JIS K7125 is 2.0 or more.
[9] The laminated foam sheet according to any one of [1] to [8], in which the foam layer includes a polypropylene-based resin.
[10] The laminated foam sheet according to any one of [1] to [9], in which the non-foam layer has a melting point of 140° C. or higher and includes a resin (P) other than the non-crosslinked olefin-based elastomer.
[11] The laminated foam sheet according to [10], in which the resin (P) includes at least one type selected from the group consisting of a polypropylene-based resin and a thermoplastic elastomer.
[12] The laminated foam sheet according to [10] or [11], in which, in the non-foam layer, a content of the resin (P) is 20 to 80% by mass with respect to 100% by mass of the resin forming the non-foam layer.
[13] The laminated foam sheet according to any one of [10] to [12], in which, in the non-foam layer, a mass ratio represented by (mass of the non-crosslinked olefin-based elastomer):(mass of the resin (P)) is 20:80 to 80:20.
[14] The laminated foam sheet according to any one of [1] to [13], in which, in the non-foam layer, a content of the non-crosslinked olefin-based elastomer is 20 to 80% by mass with respect to 100% by mass of the resin forming the non-foam layer.
[15] A molded article formed by molding the laminated foam sheet according to any one of [1] to [14].

### Advantageous Effects of Invention

According to the present invention, it is possible to provide a laminated foam sheet having a slip-resistant surface, excellent strength, and excellent thermoformability, and a molded article thereof.

### BRIEF DESCRIPTION OF DRAWINGS

FIG. 1 is a cross-sectional view showing an example of a laminated foam sheet of the present invention.

FIG. 2 is a schematic view showing an example of a manufacturing apparatus for a foam sheet.

FIG. 3 is a schematic view showing an example of a manufacturing apparatus for a laminated foam sheet of the present invention.

FIG. 4 is a perspective view showing an example of a molded product of the laminated foam sheet of the present invention.

### BEST MODE FOR CARRYING OUT THE INVENTION

### <Laminated Foam Sheet>

The laminated foam sheet of the present invention has a foam layer and a non-foam layer positioned on one surface or both surfaces of the foam layer.

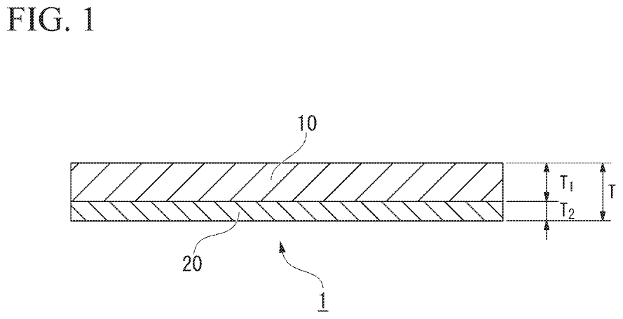

The laminated foam sheet in FIG. 1 is provided with a foam layer 10 and a non-foam layer 20 provided on one surface of the foam layer 10. A laminated foam sheet 1 has a two-layer structure.

Here, in FIG. 1, the thickness is enlarged and illustrated.

### <Foam Layer>

In the foam layer, the resin composition is foamed. The resin composition preferably contains a thermoplastic resin and a foaming agent.

Examples of the thermoplastic resin include polyolefin-based resin, polystyrene-based resin, polyester-based resin, and the like. Among these, polyolefin-based resins are preferable, and polypropylene-based resins are more preferable.

Examples of the polypropylene-based resin include propylene homopolymers, copolymers with other monomers, mixtures thereof, and the like.

As the polypropylene-based resin, a structural unit based on propylene is preferably included as 50% by mass or more with respect to all the structural units of the polypropylene-based resin, more preferably 70% by mass or more, and even more preferably 80% by mass or more. In addition, the amount may be 100% by mass. Specifically, the polypropylene-based resin preferably includes a structural unit based on propylene as 50 to 100% by mass with respect to all the structural units of the polypropylene-based resin, more preferably 70 to 100% by mass, and even more preferably 80 to 100% by mass.

As the other monomer, for example, α-olefins other than propylene such as ethylene, 1-butylene, 1-pentene, and 1-hexene are preferable. These may be used alone as one type or in a combination of two types or more.

Examples of the copolymer include a block copolymer of propylene and other monomers and a random copolymer of propylene and other monomers.

The other monomers may be used alone as one type or in a combination of two types or more.

As the polypropylene-based resin, a high melt tension polypropylene (HMS-PP) resin is preferable. A high melt tension polypropylene resin is a polypropylene resin for which tension in the molten state is increased by mixing high molecular weight components or components having a branched structure into a polypropylene resin, or by copolymerizing a long-chain branched component with polypropylene. High melt tension polypropylene resins are commercially available, for example, “WB130HMS”, “WB135HMS”, and “WB 140HMS” manufactured by Borealis AG; “Pro-fax F814” manufactured by Basell; “FB3312”, “FB5100”, “FB7200”, “FB9100”, “MFX8”, and “MFX6” manufactured by Japan Polypropylene Corporation, and the like.

Usually, it is possible to determine whether or not the polypropylene-based resin is a high melt tension polypropylene resin not only by the difference in polymer structure, but also by the magnitude of the melt tension. For example, when the melt tension is 5 cN or more, it is possible to determine that the polypropylene-based resin is a high melt tension polypropylene resin.

The melt tension of the high melt tension polypropylene resin is preferably 10 cN or more and 30 cN or less, for example. At the lower limit value or more, it is easier to increase the strength of a foam layer. At the upper limit value or less, it is easier to improve the thermoformability.

Here, the melt tension is a value measured by the following method.

### <Melt Tension (MT)>

The melt tension is measured using a twin-bore capillary rheometer Rheologic 5000T (manufactured by Ceast, Italy). That is, a measurement sample resin is filled in a 15 mm diameter barrel heated to a test temperature of 200° C., preheated for 5 minutes, then extruded in a string shape from a capillary die (diameter 2.095 mm, length 8 mm, inflow angle 90 degrees (conical)) of the measuring apparatus described above by maintaining a constant piston descending speed (0.07730 mm/s), the string-shaped material is passed through a tension detection pulley positioned 27 cm below the capillary die described above and then wound using a winding roll while gradually increasing the winding speed from an initial speed of 3.94388 mm/s with an acceleration of 12 mm/s², and the average of the maximum values and minimum values of the tension directly before the point at which the string-shaped material is cut is set as the MT of the sample resin.

The melt mass flow rate (MFR) of the polypropylene-based resin is preferably 5.0 g/10 min or less, more preferably 0.1 g/10 min or more and 5.0 g/10 min or less, and even more preferably 0.5 g/10 min or more and 4.0 g/10 min or less. When the MFR is the lower limit value described above or more, the closed cell ratio of the foam layer is easily set to 70% or more. When the MFR is the upper limit value described above or less, it is easier to increase the strength of the foam layer.

MFR is a numerical value representing the fluidity when melting the thermoplastic resin. The MFR represents the amount of resin when a resin melted in a cylinder is extruded every 10 minutes from a die having a specified diameter installed at the bottom of the cylinder by a piston under a constant temperature and load conditions.

In this specification, the MFR is a numerical value at 230° C. and 0.23 MPa.

The melting point of the polypropylene-based resin is preferably 150° C. or higher to 170° C. or lower, and more preferably 155° C. or higher to 165° C. or lower. When the melting point of a polypropylene-based resin is the lower limit value or more, it is easier to increase the strength of the foam layer. When the melting point of the polypropylene-based resin is the upper limit value described above or less, it is easier to improve the thermoformability.

The melting point of the polypropylene-based resin is measured by the method described in JIS K7121: 1987 “Method for Measuring Transition Temperature of Plastic”.

The content of the polypropylene-based resin is preferably 80% a by mass or more with respect to 100% by mass of the resin forming the foam layer, more preferably 90%/a by mass or more, and even more preferably 100% by mass. Specifically, the content of the polypropylene-based resin is preferably 80 to 100% by mass with respect to 100% by mass of the resin forming the foam layer, more preferably 90 to 100% by mass, and most preferably 100% by mass.

The resin composition may include a resin other than a polypropylene-based resin. Examples of resins other than polypropylene-based resins include polystyrene-based resins, olefin-based resins (excluding polypropylene-based resins), polyester-based resins, and the like.

Examples of polystyrene-based resins include homopolymers or copolymers of styrene-based monomers, copolymers of styrene-based monomers and other vinyl-based monomers, mixtures thereof, and the like. Polystyrene-based resins may be used alone as one type or in a combination of two types or more.

As the polystyrene-based resin, a structural unit based on a styrene-based monomer is preferably included as 50% by mass or more with respect to all the structural units of the polystyrene-based resin, more preferably included as 70% by mass or more, and even more preferably included as 80% by mass or more.

In addition, the mass average molecular weight of the polystyrene-based resin is preferably 200,000 to 400,000, and more preferably 240,000 to 400,000. The mass average molecular weight is a value obtained by converting a value measured by GPC (gel permeation chromatography) based on a calibration curve using standard polystyrene.

Examples of the styrene-based monomer homopolymer or copolymer include homopolymers or copolymers of styrene-based monomers such as styrene, α-methylstyrene, vinyltoluene, chlorostyrene, ethylstyrene, i-propylstyrene, dimethylstyrene, and bromostyrene. These may be used alone as one type or in a combination of two types or more. Among these, examples having a structural unit based on styrene as 50% by mass or more with respect to all of the structural units are preferable, and polystyrene having 100% by mass is more preferable.

In addition, high impact polystyrene including a rubber component may be used as the polystyrene-based resin.

Examples of copolymers of styrene-based monomers and other vinyl-based monomers include styrene-(meth)acrylic acid copolymers, styrene-(meth)acrylic acid ester copolymers, styrene-vinyl chloride copolymers, styrene-butadiene copolymers, styrene-acrylonitrile copolymers, styrene-maleic anhydride copolymers, styrene-maleic acid ester copolymers, styrene-fumaric acid ester copolymers, styrene-divinylbenzene copolymers, styrene-alkylene glycol dimethacrylate copolymers, (meth)acrylic acid ester-butadiene-styrene copolymers (for example, MBS resin), and the like.

In this specification, (meth)acrylic acid means acrylic acid or methacrylic acid.

Copolymers of styrene-based monomers and other vinyl-based monomers include copolymers including 50% by mass or more of structural units based on styrene-based monomers with respect to all of the structural units of the copolymer, more preferably copolymers including 70% by mass or more, and even more preferably copolymers including 80% by mass or more. Specifically, as copolymers of a styrene-based monomer and another vinyl-based monomer, copolymers including structural units based on the styrene-based monomer as 50% by mass or more and less than 100% by mass with respect to all the structural units of the copolymer are preferable, copolymers including 70% by mass or more and less than 100% by mass are more preferable, and copolymers including 80% by mass or more and less than 100% by mass are even more preferable.

As a copolymer of a styrene-based monomer and another vinyl-based monomer, a styrene-(meth)acrylic acid copolymer and a styrene-butadiene copolymer are preferable. Examples of the styrene-(meth)acrylic acid copolymer include a styrene-acrylic acid copolymer and a styrene-methacrylic acid copolymer.

As the styrene-(meth)acrylic acid copolymer, a copolymer where the content of the structural unit based on (meth)acrylic acid in the copolymer is 1 to 14% by mass with respect to all of the structural units of the copolymer is preferable, a copolymer with 1% by mass or more and less than 14% by mass is more preferable, and a copolymer with 4 to 10% by mass is even more preferable.

As the styrene-butadiene copolymer, a copolymer where the content of the structural unit based on butadiene in the copolymer is 1 to 14% by mass with respect to all the structural units of the copolymer is preferable, a copolymer with 1% by mass or more and less than 14% by mass is more preferable, and a copolymer with 4 to 10% by mass is even more preferable.

The content of the structural unit based on (meth)acrylic acid in the polystyrene-based resin is preferably 0.5 to 6.8% by mass with respect to all the structural units forming the polystyrene-based resin, more preferably 1.0 to 5.0% by mass, and even more preferably 1.3 to 3.0% by mass. Setting the content in the numerical range described above makes it possible to exhibit excellent toughness and heat resistance. It is possible to calculate the content of the structural unit based on (meth)acrylic acid in the polystyrene-based resin by calculation from the charged amount of styrene-(meth)acrylic acid.

The content of the structural unit based on butadiene in the polystyrene-based resin is preferably 0.5 to 6.8% by mass with respect to all the structural units forming the polystyrene-based resin, more preferably 1.0 to 5.0% by mass, and even more preferably 1.3 to 3.0% by mass. Setting the content in the numerical range described above makes it possible to exhibit excellent toughness and heat resistance.

It is possible to calculate the content of the structural unit based on butadiene in the polystyrene-based resin by calculation from the charged amount of styrene-butadiene.

In the polystyrene-based resin, the content of the styrene-(meth)acrylic acid copolymer is preferably 10% by mass or more with respect to the total mass of the polystyrene-based resin. When the content of the styrene-(meth)acrylic acid copolymer is the lower limit value described above or more, it is easy to improve the fusion property.

The content of the styrene-(meth)acrylic acid copolymer in the polystyrene-based resin is not particularly limited and may be 100% by mass with respect to the total mass of the polystyrene-based resin.

The content of the styrene-butadiene copolymer in the polystyrene-based resin is preferably 10% by mass or more with respect to the total mass of the polystyrene-based resin. Specifically, the content of the styrene-butadiene copolymer in the polystyrene-based resin is preferably 10 to 100% by mass with respect to the total mass of the polystyrene-based resin. When the content of the styrene-butadiene copolymer is the lower limit value described above or more, it is easy to improve the fusion property.

The content of the styrene-butadiene copolymer in the polystyrene-based resin is not particularly limited and may be 100% by mass with respect to the total mass of the polystyrene-based resin.

As polystyrene-based resins, it is possible to use commercially available polystyrene-based resins, polystyrene-based resins synthesized by suspension polymerization methods or the like, and polystyrene-based resins (virgin polystyrene) which are not recycled materials, in addition, it is possible to use recycled materials obtained by carrying out a restoring process on used polystyrene-based foam bodies, polystyrene-based resin foam molded articles (such as food packaging trays), and the like. Examples of recycled materials include recycled materials obtained by recovering used polystyrene-based foam bodies and polystyrene-based resin foam molded articles and restoring the above using a limonene dissolution method or a heat volume reduction method.

Examples of polyolefin-based resins (excluding polypropylene-based resins) include polyethylene-based resins, cyclic polyolefin-based resins, and the like. Polyolefin-based resins may be used alone as one type or in a combination of two types or more.

Examples of the polyethylene-based resin include a low-density polyethylene resin (LDPE) in which ethylene is polymerized under high pressure and a long chain branch is formed in the molecule, a high-density polyethylene resin (HDPE) with a density of 0.942 g/cm³ or more in which ethylene is polymerized under medium to low pressure using a Ziegler-Natta catalyst or a metallocene catalyst, a linear low-density polyethylene resin (LLDPE) with a density of less than 0.942 g/cm³ in which a small amount of α-olefin such as I-butene, I-hexene, or I-octene is added in the HDPE polymerization process to form a short chain branch in the molecule, and the like.

Examples of the cyclic polyolefin-based resin include a copolymer (COC) of ethylene and norbornene, a polymer (COP) obtained by polymerizing cyclopentanediol by a metathesis reaction, and the like.

Polyester-based resins include polyethylene terephthalate resin, polybutylene terephthalate resin, polyethylene naphthalate resin, polyethylene furanoate resin, polybutylene naphthalate resin, copolymers of terephthalic acid, ethylene glycol, and cyclohexanedimethanol, mixtures thereof, mixtures thereof with other resins, and the like. In addition, plant-derived polyethylene terephthalate resins and polyethylene furanoate resins may also be used. Polyester-based resins may be used alone as one type or in a combination of two types or more.

Furthermore, a (meth)acrylic-based resin, an acrylonitrile-styrene copolymer, an acrylonitrile-butadiene-styrene copolymer, a polyphenylene ether-based resin, or the like may be included.

The resin composition contains a foaming agent.

Examples of the foaming agent include inorganic degradable foaming agents such as ammonium carbonate, sodium bicarbonate, ammonium bicarbonate, ammonium nitrite, calcium azide, sodium azide, and sodium borohydride; azo compounds such as azodicarbonamide, azobissulfuramide, azo bisisobutyronitrile, and diazoaminobenzene; nitroso compounds such as N,N′-dinitrosopentamethylenetetramine and N,N′-dimethyl-N,N′-dinitrosoterephthalamide; benzenesulfonyl hydrazide, p-toluenesulfonyl hydrazide, p,p′-oxybisbenzensulfonyl semicarbazide, p-toluenesulfonyl semicarbazide, trihydrazinotriazine, barium azodicarboxylate, and the like. Examples of gas foaming agents include air, nitrogen, carbon dioxide, propane, neopentane, methyl ether, dichloride fluoride methane, n-butane, isobutane, and the like. Here, “gas” means a gas at normal temperature (15° C. to 25° C.). On the other hand, examples of the volatile foaming agent include ether, petroleum ether, acetone, pentane, hexane, isohexane, heptane, isoheptane, benzene, toluene, and the like.

Among the foaming agents described above, n-butane and nitrogen are particularly preferable.

The content of the foaming agent in the resin composition is appropriately determined in consideration of the type, specific gravity, and the like of the foaming agent, and, for example, 0.5 to 20 parts by mass with respect to 100 parts by mass of the resin is preferable, and 0.8 to 5.5 parts by mass is more preferable.

The content of the foaming agent in the foam layer (so-called residual gas amount) is preferably 0.3 to 3.6% by mass with respect to the total mass of the foam layer, and more preferably 0.5 to 3.3% by mass.

Additives such as surfactants, bubble regulators, cross-linking agents, fillers, flame retardants, flame retardant aids, lubricants (hydrocarbons, fatty acids, fatty acid amides, esters, alcohols, metal soaps, silicone oils, and waxes such as low molecular weight polyethylene, and the like), spreading agents (liquid paraffin, polyethylene glycol, polybutene, and the like), colorants, heat stabilizers, ultraviolet absorbers, and anti-oxidants may be added to the resin composition.

Examples of bubble regulators include inorganic powders such as talc and silica; acidic salts of polyvalent carboxylic acids; reaction mixtures of polyvalent carboxylic acids and sodium carbonate or sodium bicarbonate, and the like. Among the above, the reaction mixture is preferable from the point of maintaining a closed cell ratio and easily improving formability.

The bubble regulator may be used alone as one type or in a combination of two types or more.

The added amount of the bubble regulator is preferably 0.01 to 1.0 part by mass with respect to 100 parts by mass of the resin.

The closed cell ratio of the foam layer is 70% or more, preferably 75% or more, and more preferably 80% or more. The upper limit value is not specifically limited and, for example, 99% or less is preferable. Specifically, the closed cell ratio of the foam layer is preferably 70 to 99%, more preferably 75 to 99%, and even more preferably 80 to 99%. When the closed cell ratio of the foam layer is in the numerical range described above, the impact resistance is excellent and the thermoformability is more easily improved.

The closed cell ratio of the foam layer is measured by the method described in JIS K7138: 2006 “Hard foamed plastics—How to determine open cell ratios and closed cell ratios”.

The thickness T₁ of the foam layer is appropriately determined according to the determined strength and the like and, for example, is preferably 2.0 to 6.0 mm, and more preferably 2.5 to 5.0 mm. When the thickness of the foam layer is the lower limit value described above or more, the shape retaining property is excellent. It is possible to further improve the formability when the thickness of a foam layer is the upper limit value described above or less.

In this specification, the thickness is a value obtained by measuring 20 points at equal intervals in the width direction (TD direction) of the measurement object using a macro gauge and using the arithmetic average value thereof.

The basis weight of the foam layer is preferably 200 to 700 g/m², and more preferably 400 to 600 g/m². When the basis weight of the foam layer is in the numerical range described above, the handleability is excellent.

It is possible to measure the basis weight by the following method.

Excluding 20 mm at both ends in the width direction of the foam layer, 10 pieces of 10 cm×10 cm are cut out at equal intervals in the width direction, and the mass (g) of each piece is measured up to 0.001 g units. A value obtained by converting the average value of the mass (g) of each piece into a mass per 1 m² is set as the basis weight (g/m²) of the foam layer.

The density of the foam layer is preferably 90 to 350 Kg/m³, and more preferably 100 to 300 Kg/m³. When the density of the foam layer is in the numerical range described above, the handleability is excellent.

### <Method for Manufacturing Foam Sheet>

The foam sheet forming the foam layer is manufactured according to a manufacturing method known in the related art.

Examples of the method for manufacturing a foam sheet include a method of preparing a resin composition, extruding the resin composition into a sheet shape, and carrying out foaming (primary foaming) (extrusion foaming method).

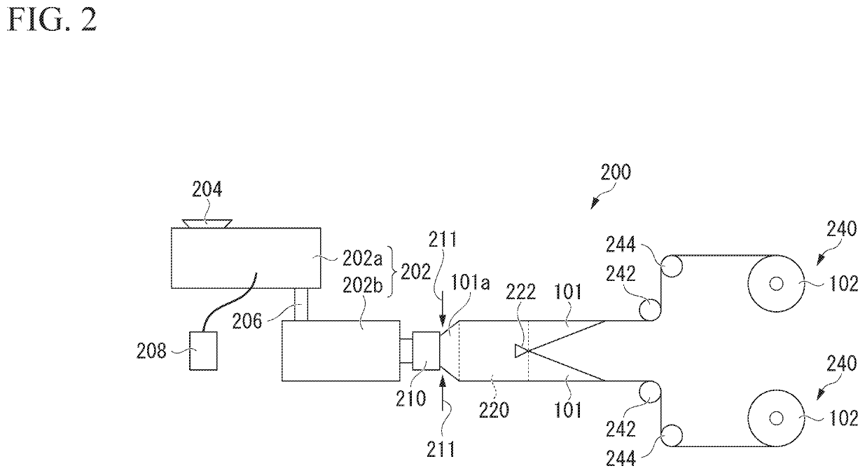

A description will be given of an example of a method for manufacturing a foam sheet, using FIG. 2.

A foam sheet manufacturing apparatus 200 in FIG. 2 is an apparatus for obtaining a foam sheet by inflation molding and is provided with an extruder 202, a foaming agent supply source 208, a circular die 210, a mandrel 220, and two winders 240.

The extruder 202 is a so-called tandem extruder and has a configuration in which a first extrusion part 202a and a second extrusion part 202b are connected by a pipe 206. The first extrusion part 202a is provided with a hopper 204 and a foaming agent supply source 208 is connected to the first extrusion part 202a.

A circular die 210 is connected to the second extrusion part 202b and a mandrel 220 is provided downstream of the circular die 210. The mandrel 220 is provided with a cutter 222.

First, the raw materials forming the resin composition are charged from the hopper 204 into the first extrusion part 202a. The raw materials charged from the hopper 204 are the resin forming the foam sheet, an additive blended as necessary, and the like.

In the first extrusion part 202a, the raw materials are mixed while heating to an arbitrary temperature to make a resin melt, a foaming agent is supplied from the foaming agent supply source 208 to the first extrusion part 202a, and the foaming agent is mixed with the resin melt to obtain a resin composition.

The heating temperature is appropriately determined in a range in which the resin is melted and the additive is not denatured in consideration of the type of the resin or the like.

The resin composition is supplied from the first extrusion part 202a to the second extrusion part 202b via the pipe 206, further mixed, cooled to an arbitrary temperature, and then supplied to the circular die 210. The temperature of the resin composition at the time of extrusion from the circular die 210 is 140 to 190° C., and more preferably 150 to 190° C.

The resin composition is extruded from the circular die 210 and the foaming agent is foamed to make a cylindrical foam sheet 101a. Cooling air 211 is blown onto the foam sheet 10a extruded from the circular die 210 and then the foam sheet 101a supplied to the mandrel 220. It is possible to adjust the cooling rate of the foam sheet 101a through a combination of the temperature, amount, and blowing position of the cooling air 211.

The cylindrical foam sheet 101a is made to have an arbitrary temperature by the mandrel 220, sized, and cut into two sheets by the cutter 222 to form the foam sheet 101. The foam sheet 101 is wound around each of a guide roll 242 and a guide roll 244, and wound around a winder 240 to form a foam sheet roll 102.

The foaming multiple of the foam sheet is, for example, 2 to 20 times.

Here, the foam sheet may be manufactured by a method other than inflation molding.

### <Non-Foam Layer>

The non-foam layer includes a non-crosslinked olefin-based elastomer.

In the present specification, “non-crosslinked” means that the gel fraction is 3.0% by mass or less, and more preferably 1.0% by mass or less. The gel fraction is a value measured as follows.

A mass W1 of the resin is measured. Next, the resin is heated at reflux for 3 hours in 80 ml of boiling xylene. Next, the residue in xylene is filtered using a 200-mesh wire mesh, the residue remaining on the wire mesh is washed with new xylene, then naturally dried for 1 day, then dried at 120° C. for 2 hours in a dryer, and a mass W2 of the residue remaining on the wire mesh is measured. Subsequently, the gel fraction of the resin is calculated based on Formula (1).

Gel fraction (% by mass)=100×W2/W1 (1)

The non-crosslinked olefin-based elastomer is preferably a copolymer of a propylene homopolymer and propylene and one type or more of α-olefin selected from the group consisting of ethylene. I-butene, 1-pentene, 1-hexene, 1-octene, and 4-methyl-1-pentene, or the like.

The content of the non-crosslinked olefin-based elastomer is preferably 20% by mass or more with respect to 100% by mass of the resin forming the non-foam layer, more preferably 40% by mass or more, even more preferably 60% by mass or more, and particularly preferably 80% by mass or more. The content of the non-crosslinked olefin-based elastomer is preferably 80% by mass or less with respect to 100% by mass of the resin forming the non-foam layer and more preferably 60% by mass or less. Specifically, the content of the non-crosslinked olefin-based elastomer is preferably 20 to 80% by mass with respect to 100% by mass of the resin forming the non-foam layer and more preferably 40 to 60% by mass.

As a resin other than the non-crosslinked olefin-based elastomer, the non-foam layer may include a polypropylene-based resin, a polystyrene-based resin, an olefin-based resin (excluding the polypropylene-based resin), a polyester-based resin, and the like described in <Foam Layer> above. In particular, it is preferable to include a resin (P) other than the non-crosslinked olefin-based elastomer, for which the melting point is 140° C. or higher.

The resin (P) is preferably at least one type of resin selected from the group consisting of a polypropylene-based resin and a thermoplastic elastomer.

Examples of the polypropylene-based resin include the polypropylene resins described in <Foam Layer> above.

Examples of thermoplastic elastomers include olefin-based elastomers, styrene-based elastomers, polyester-based elastomers, polyurethane-based elastomers, and the like. Among these, olefin-based elastomers and styrene-based elastomers are preferable.

In the non-foam layer, the content of the resin (P) is preferably 20 to 80% by mass with respect to 100% by mass of the resin forming the non-foam layer, and more preferably 30 to 70% by mass, and even more preferably 40 to 60% by mass. When the content of the resin (P) is in the above range, the thermoformability is easily improved.

In the non-foam layer, the mass ratio represented by (mass of non-crosslinked olefin-based elastomer):(mass of resin (P)) is preferably 20:80 to 80:20, more preferably 30:70 to 70:30, and even more preferably 40:60 to 60:40. When the mass ratio is in the range described above, it is easy to improve thermoformability.

The thickness T₂ of the non-foam layer is appropriately determined according to the determined strength and the like and is preferably 0.1 to 0.3 mm, and more preferably 0.12 to 0.2 mm. When the thickness T₂ is the lower limit value described above or more, sufficient strength is easily obtained. When the thickness T₂ described above is the upper limit value described above or less, forming processing is easy.

The Duro A hardness of the non-foam layer determined in accordance with JIS K6253-3 is preferably 70 or less, more preferably 30 to 70, and even more preferably 30 to 60. When the Duro A hardness is in the range described above, the grip property is excellent.

The fracture point elongation percentage of the non-foam layer determined in accordance with JIS K6251 is preferably 900% or more, and more preferably 1000 to 1500%. When the fracture point elongation percentage is in the above ranges, the molding followability is excellent.

The non-foam layer may include an additive. Examples of the additives include flame retardants, flame retardant aids, lubricants, spreading agents, colorants, anti-static agents, anti-fogging agents, anti-blocking agents, anti-oxidants, light stabilizers, crystal nucleating agents, surfactants, fillers, and the like.

In a case where the additive is included in the non-foam layer, the content thereof is preferably more than 0 parts by mass and 30 parts by mass or less with respect to 100 parts by mass of the resin.

The thickness T of the laminated foam sheet 1 is appropriately determined in consideration of the application or the like and is preferably 2.0 to 6.5 mm, and more preferably 2.5 to 5.5 mm. If the thickness of the laminated foam sheet is the lower limit value described above or more, it is easy to obtain sufficient strength. If the thickness is the upper limit value described above or less, forming processing is easy.

The basis weight of the laminated foam sheet is preferably 500 to 1500 g/m², and more preferably 750 to 1300 g/m². When the basis weight of the laminated foam sheet is in the numerical range described above, the handleability is excellent.

It is possible to measure the basis weight by the following method.

Excluding 20 mm at both ends in the width direction of the laminated foam sheet, 10 pieces of 10 cm×10 cm are cut out at equal intervals in the width direction, and the mass (g) of each piece is measured up to 0.001 g units. The value obtained by converting the average value of the mass (g) of each piece into the mass per 1 m² is set as the basis weight (g/m²) of the laminated foam sheet.

The density of the laminated foam sheet is preferably 100 to 400 Kg/m³, and more preferably 150 to 350 Kg/m³. When the density of the laminated foam sheet is in the numerical range described above, the handleability is excellent.

The bending strength of the laminated foam sheet determined in accordance with JIS K7171 is preferably 6.0 MPa or less, more preferably 2.5 MPa or more and 5.0 MPa or less, and even more preferably 3.0 MPa or more and 4.5 MPa or less. When the bending strength of the laminated foam sheet is in the range described above, the handleability is excellent.

The bending strength of the laminated foam sheet determined in accordance with JIS K7171 in the TD direction (width direction) is preferably 6.0 MPa or less, more preferably 2.5 MPa or more and 5.0 MPa or less, and even more preferably 3.0 MPa or more and 4.5 MPa or less. When the bending strength of the laminated foam sheet is in the range described above, the handleability is excellent.

The bending strength of the laminated foam sheet determined in accordance with JIS K7171 in the MD direction (length direction) is preferably 6.0 MPa or less, more preferably 2.5 MPa or more and 5.0 MPa or less, and even more preferably 3.0 MPa or more and 4.5 MPa or less. When the bending strength of the laminated foam sheet is in the range described above, the handleability is excellent.

The maximum displacement of the laminated foam sheet determined in accordance with JIS K7171 is preferably 10 mm or more, more preferably 12 mm or more, and even more preferably 12.5 to 17 mm. When the maximum displacement of the laminated foam sheet is in the range described above, the formability is excellent.

The maximum displacement of the laminated foam sheet determined in accordance with JIS K7171 in the TD direction is preferably 10 mm or more, more preferably 12 mm or more, and even more preferably 12.5 to 17 mm. When the maximum displacement of the laminated foam sheet is in the range described above, the formability is excellent.

The maximum displacement of the laminated foam sheet determined in accordance with JIS K7171 in the MD direction is preferably 10 mm or more, more preferably 12 mm or more, and even more preferably 12.5 to 17 mm. When the maximum displacement of the laminated foam sheet is in the range described above, the formability is excellent.

The maximum static friction coefficient of the laminated foam sheet determined in accordance with JIS K7125 is preferably 2.0 or more, more preferably 2.5 or more, and even more preferably 3.0 to 4.5. When the maximum static friction coefficient of the laminated foam sheet is in the range described above, it is possible to make it hard for slipping to occur.

As the counterpart material for measuring the static friction coefficient, it is preferable to use an aluminum material mirror finish in order to ascertain the slipperiness.

### <Method for Manufacturing Laminated Foam Sheet>

A description will be given of an example of a method for manufacturing the laminated foam sheet 1.

The manufacturing method of the laminated foam sheet 1 is preferably provided with, for example, a foam sheet forming step for obtaining a foam sheet, a non-foam sheet forming step for obtaining a non-foam sheet which forms a non-foam layer, and a laminating step for heat-sealing the foam sheet and the non-foam sheet.

The foam sheet forming step is the same as the method for manufacturing a foam sheet described above.

In the non-foam sheet forming step, it is possible to adopt a method for producing a non-foam sheet known in the related art and examples thereof include an inflation molding method, an extrusion molding method, and the like.

The laminating step is a step of providing a non-foam layer formed of a non-foam sheet on a foam layer formed of a foam sheet.

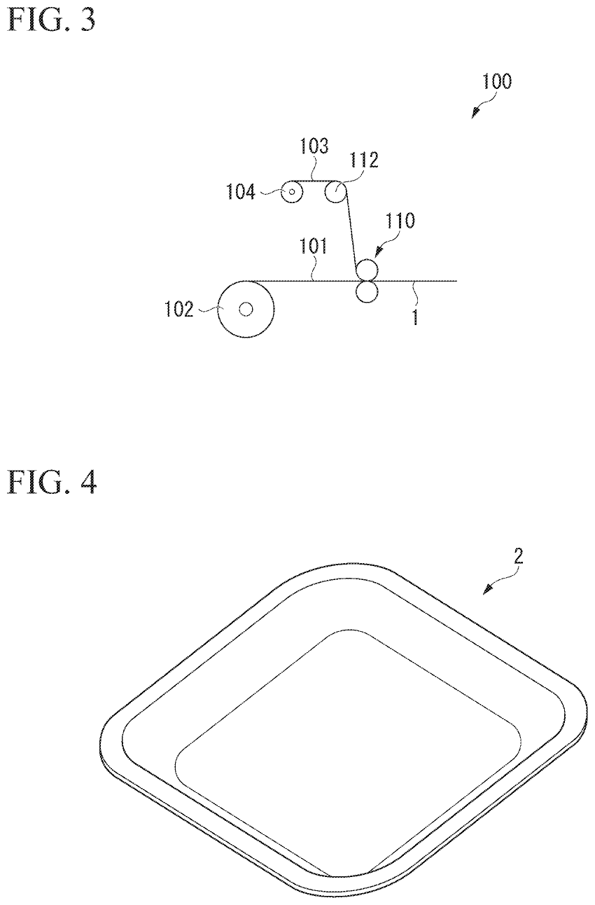

A description will be given below of an example of the laminating step in a thermocompression bonding method, using FIG. 3.

A laminated foam sheet manufacturing apparatus 100 of FIG. 3 is provided with a thermal laminator 110.

The thermal laminator 110 is provided with a pair of heating rolls, and it is possible to heat the surface of the heating rolls to an arbitrary temperature.

A rolled body (non-foam sheet roll) 104 of the foam sheet roll 102 and the non-foam sheet 103 is mounted on each sheet feeding machine.

The foam sheet 101 is fed out from the foam sheet roll 102 and supplied to the thermal laminator 110. The non-foam sheet 103 is fed out from the non-foam sheet roll 104, and the non-foam sheet 103 is wound around the guide roll 112 and then supplied to the thermal laminator 110.

In the thermal laminator 110, the foam sheet 101 and the non-foam sheet 103 are laminated in this order and the result is heated at an arbitrary temperature while interposed between a pair of heating rolls to pressure-bond the foam sheet 101 and the non-foam sheet 103. The temperature at which the foam sheet 101 and the non-foam sheet 103 are pressure-bonded (pressure-bonding temperature) is, for example, preferably 140 to 200° C., and more preferably 160 to 180° C. Even at a comparatively low pressure-bonding temperature, the foam sheet 101 of the present embodiment is pressure-bonded to the non-foam sheet 103 and bubbles are not easily generated. In this manner, the laminated foam sheet 1 provided with the foam layer 10 and the non-foam layer 20 is obtained. The heating temperature in the laminating step is appropriately determined according to the material and the like of each layer.

In addition, the laminated foam sheet of the present invention is not limited to the manufacturing method described above (thermal lamination method) and the foam layer and the non-foam layer may be laminated by coextrusion.

The laminated foam sheet of the present invention may have a non-foam layer on only one surface of the foam layer, or may have a non-foam layer on both surfaces of the foam layer.

### <Molded Article>

It is possible to obtain the molded article of the present invention by molding a laminated foam sheet.

FIG. 4 is a perspective view showing an example of a container which is a molded product of a laminated foam sheet.

Examples of a method of molding the laminated foam sheet include a method in which the laminated foam sheet is heated to an arbitrary temperature for secondary foaming and then the laminated foam sheet is interposed between a male mold and a female mold of an arbitrary shape to carry out molding. At this time, in a case where the non-foam layer is laminated on only one surface of the foam layer, molding is preferably performed such that the non-foam layer becomes the outside of the molded article.

Examples of the molded article of the present invention include applications as a container such as a container for home appliance packaging, a machine part packaging container, or a food packaging container. Among the above, a machine part packaging container is preferable.

### EXAMPLES

A more detailed description will be given below of the present invention through Examples and Comparative Examples, but the present invention is not limited to the following Examples.

### Example 1

A polymer component was prepared by mixing at a ratio of 45 parts by mass of “WB140HMS” (melt tension: 23 cN, melt flow rate: 1.7 g/10 min) manufactured by Borealis AG, as a polypropylene-based resin, 50 parts by mass of product name “BC6C” manufactured by Nippon Polypro Co., Ltd., as block polypropylene, and 10 parts by mass of product name “Q100F” manufactured by SunAllomer Ltd. as a polyolefin-based thermoplastic elastomer (TPO). A mixture was obtained by blending a sodium bicarbonate-based foaming agent (master batch manufactured by Dainichiseika Color & Chemicals Mfg Co., Ltd., product name “Finecell Master PO410K”) in which the ratio was 0.2 parts by mass with respect to 100 parts by mass in total of the polymer component. A tandem extruder in which a second extruder having a diameter of 115 mm was connected to the tip of a first extruder having a diameter of 90 mm was prepared. The mixture was supplied to the first extruder and melt-kneaded at approximately 200 to 210° C. Subsequently, butane (normal butane:isobutane=65:35 (mass ratio)) as a foaming agent was press-fitted into the first extruder so as to be 1.0 part by mass with respect to a total of 100 parts by mass of the polymer component and then further melt-kneading was carried out. After that, the result was cooled to approximately 175C and supplied to a cyclic cyclic die connected to the tip of the second extruder, and extrusion-foamed in a cylindrical shape with an extrusion rate of 150 Kg/hour.

The obtained cylindrical foam body was cooled by blowing air onto the inner surface thereof. Thereafter, the inner surface was solidified over the cooling mandrel plug and air was also blown onto the outer surface of the plug to carry out cooling and solidification. Subsequently, the cylindrical foam body was cut and opened in the extrusion direction and wound into a roll shape as a continuous sheet to obtain a foam sheet having a thickness of 3.0 mm and a basis weight of 540 g/m².

A non-crosslinked olefin-based elastomer resin (manufactured by JSR Corporation, product name “3400B” gel fraction 0.3% by mass) was supplied to the obtained foam sheet in the third extruder and the fourth extruder.

A sheet was extruded from a T-die attached to the tip of the third extruder and, in a molten state immediately after extrusion, the sheet was laminated on one surface of the foam sheet and fused thereto. Subsequently, a sheet was extruded from a T-die attached to the tip of the fourth extruder and, in a molten state immediately after extrusion, the sheet was laminated on the other surface of the foam sheet and fused thereto. Due to this, a laminated foam sheet which had a non-foam layer on both surfaces was obtained. The extrusion conditions for the third extruder and the fourth extruder were the same. All of the T dies were adjusted such that the temperature at both end portions of the resin flow path in the width direction was 240° C. and the temperature at the portions other than both end portions was 260° C.

### Example 2

A foam sheet having a thickness of 3.0 mm and a basis weight of 450 g/m² was obtained in the same manner as in Example 1 except that the discharge rate was adjusted to be 125 Kg/h.

The obtained foam sheet was used to obtain a laminated foam sheet in the same manner as in Example 1.

### Example 3

After obtaining a foam sheet in the same manner as in Example 2, the take-up speed of the foam sheet was adjusted to 1/2 during lamination to obtain a laminated foam sheet.

### Example 4

A laminated foam sheet was obtained in the same manner as in Example 2 except that a non-crosslinked olefin-based elastomer resin (manufactured by JSR Corporation, product name “3400B”) was changed to a non-crosslinked olefin-based elastomer resin (manufactured by JSR Corporation, product name “3600B”, gel fraction 0.5% by mass).

### Example 5

A laminated foam sheet was obtained in the same manner as in Example 3 except that the non-crosslinked olefin-based elastomer resin (product name “3400B” manufactured by JSR Corporation) was changed to a non-crosslinked olefin-based elastomer resin (product name “3600B” manufactured by JSR Corporation).

### Example 6

A laminated foam sheet was obtained in the same manner as in Example 3 except that the non-crosslinked olefin-based elastomer resin (product name “3400B” manufactured by JSR Corporation) was changed to a non-crosslinked olefin-based elastomer resin (product name “3700B” manufactured by JSR Corporation, gel fraction 0.7% by mass).

### Comparative Example 1

A laminated foam sheet was obtained in the same manner as in Example 2 except that the non-crosslinked olefin-based elastomer resin was changed to a polypropylene-based resin (product name “BC6C” manufactured by Mitsubishi Chemical Corporation).

### Comparative Example 2

A laminated foam sheet was obtained in the same manner as in Example 2 except that the non-crosslinked olefin-based elastomer resin was changed to a mixture of 43 parts by mass of Talpet 70P (manufactured by Nitto Funka Kogyo K.K.) containing 70% by mass of inorganic filler in 100 parts by mass of a polypropylene-based resin (product name “BC6C”, manufactured by Mitsubishi Chemical Corporation).

### Comparative Example 3

A foam sheet was obtained in the same manner as in Example 1 except that the non-foam sheet was not provided.

### Comparative Example 4

A laminated foam sheet was obtained in the same manner as in Example 2 except that the non-crosslinked olefin-based elastomer resin was changed to a dynamically cross-linked olefin-based elastomer (product name “1301B”, manufactured by JSR Corporation, gel fraction 40% by mass).

### Comparative Example 5

A laminated foam sheet was obtained in the same manner as in Example 2 except that the non-crosslinked olefin-based elastomer resin was changed to a dynamically cross-linked olefin-based elastomer (product name “703B” manufactured by JSR Corporation, gel fraction 39.5% by mass).

### Comparative Example 6

Butane (normal butane:isobutane=65:35 (mass ratio)) as a foaming agent was press-fitted in the first extruder so as to be 0.5 parts by mass with respect to 100 parts by mass of the polymer component, and further melt-kneading was carried out. After that, the result was cooled to approximately 185° C., and the take-up speed was appropriately adjusted at a discharge rate of 125 Kg/h to obtain a foam sheet having a thickness of 1.2 mm and a basis weight of 250 g/m².

A laminated foam sheet was obtained in the same manner as in Example 2 except that the obtained foam sheet was used.

### Comparative Example 7

The same process as in Example 2 was carried out except that the non-crosslinked olefin-based elastomer resin was changed to a styrene-based elastomer (product name “TR2000” manufactured by JSR Corporation); however, it was not possible to obtain a laminated foam sheet.

### Comparative Example 8

Butane (normal butane:isobutane=65:35 (mass ratio)) as a foaming agent was press-fitted in the first extruder so as to be 1.1 parts by mass with respect to 100 parts by mass of the polymer component, and further melt-kneading was carried out. After that, the result was cooled to approximately 185° C., and the take-up speed was appropriately adjusted at a discharge rate of 125 Kg/h to obtain a foam sheet having a thickness of 2.3 mm and a basis weight of 350 g/m².

A laminated foam sheet was obtained in the same manner as in Example 2 except that the obtained foam sheet was used.

For the obtained laminated foam sheet, the thickness of the foam layer, basis weight, density, closed cell ratio, melting point of the resin included in the foam layer, thickness of the non-foam layer, Duro A hardness, fracture point elongation percentage, melting point of the resin included in the non-foam layer, thickness of the entire laminated foam sheet, basis weight, density, maximum static friction coefficient, bending strength, and maximum displacement were measured. Furthermore, the thermoformability (1) and thermoformability (2) of the laminated foam sheet were evaluated. The obtained results are shown in Tables 1 and 2.

### Example 7

A foam sheet having a thickness of 3.0 mm and a basis weight of 340 g/m² was obtained in the same manner as in Example 1 except that the discharge rate was adjusted to 110 Kg/h. A resin mixture in which 60 parts by mass of a non-crosslinked olefin-based elastomer resin (manufactured by JSR Corporation, product name “3400B” gel fraction 0.3% by mass) and 40 parts by mass of a polypropylene-based resin (product name “Q100F” manufactured by SunAllomer Ltd.) were mixed was supplied to the third extruder and the fourth extruder. After that, in the same manner as in Example 1, a laminated foam sheet having non-foam layers on both surfaces of a foam layer was obtained.

### Example 8

A foam sheet having a thickness of 3.0 mm and a basis weight of 340 g/m² was obtained in the same manner as in Example 1 except that the amount of the foaming agent was set to 1.5 parts by mass.

A laminated foam sheet was obtained in the same manner as in Example 7 except that the take-up speed of the foam sheet during lamination was adjusted to 1/2.

### Example 9

In the same manner as in Example 7, a foam sheet having a thickness of 3.0 mm and a basis weight of 340 g/m² was obtained.

A laminated foam sheet was obtained in the same manner as in Example 7 except that the take-up speed of the foam sheet during lamination was adjusted to 2/3.

### Example 10

A foam sheet having a thickness of 2.0 mm and a basis weight of 540 g/m² was obtained in the same manner as in Example 1 except that the discharge rate was adjusted to 135 Kg/h.

Thereafter, in the same manner as in Example 7, a laminated foam sheet having non-foam layers on both surfaces of a foam layer was obtained.

### Example 11

A foam sheet having a thickness of 6.0 mm and a basis weight of 560 g/m² was obtained in the same manner as in Example 1 except that the discharge rate was adjusted so as to be 130 Kg/h.

Thereafter, in the same manner as in Example 7, a laminated foam sheet having non-foam layers on both surfaces of a foam layer was obtained.

### Example 12

In the same manner as in Example 7, a foam sheet having a thickness of 3.0 mm and a basis weight of 340 g/m² was obtained.

A resin mixture in which 60 parts by mass of non-crosslinked olefin-based elastomer resin (product name “3400B” manufactured by JSR Corporation, gel fraction 0.3% by mass) and 40 parts by mass of polypropylene-based resin (product name “Q100F”, manufactured by SunAllomer Ltd.) were mixed was supplied to the third extruder.

A sheet was extruded from a T-die attached to the tip of the third extruder and, in a molten state immediately after extrusion, the sheet was laminated on one surface of the foam sheet and fused. Due to this, a laminated foam sheet having a non-foam layer on one surface was obtained.

### Example 13

In the same manner as in Example 7, a foam sheet having a thickness of 3.0 mm and a basis weight of 340 g/m² was obtained.

A resin mixture in which 80 parts by mass of non-crosslinked olefin-based elastomer resin (product name “3400B” manufactured by JSR Corporation, gel fraction 0.3% by mass) and 20 parts by mass of polypropylene-based resin (product name “Q100F”, manufactured by SunAllomer Ltd.) were mixed was supplied to the third extruder and the fourth extruder. Thereafter, in the same manner as in Example 1, a laminated foam sheet having non-foam layers on both surfaces of a foam layer was obtained.

### Example 14

In the same manner as in Example 7, a foam sheet having a thickness of 3.0 mm and a basis weight of 340 g/m² was obtained. A resin mixture in which 20 parts by mass of non-crosslinked olefin-based elastomer resin (manufactured by JSR Corporation, product name “3400B” gel fraction 0.3% by mass) and 80 parts by mass of polypropylene-based resin (product name “Q100F”, manufactured by SunAllomer Ltd.) were mixed was supplied to the third extruder and the fourth extruder. Thereafter, in the same manner as in Example 1, a laminated foam sheet having non-foam layers on both surfaces of a foam layer was obtained.

### Example 15

A laminated foam sheet was obtained in the same manner as in Example 7 except that the non-crosslinked olefin-based elastomer resin (manufactured by JSR Corporation, product name “3400B”) was changed to the non-crosslinked olefin-based elastomer resin (product name “3700B” manufactured by JSR Corporation).

### Example 16

A laminated foam sheet having non-foam layers on both surfaces of a foam layer was obtained in the same manner as in Example 7 except that 40 parts by mass of a polypropylene-based resin (manufactured by SunAllomer Ltd., product name “Q100F”) was changed to 40 parts by mass of an ethylene-propylene copolymer (product name “Q300F”, manufactured by SunAllomer Ltd.).

### Example 17

A laminated foam sheet having non-foam layers on both surfaces of a foam layer was obtained in the same manner as in Example 7 except that 60 parts by mass of non-crosslinked olefin-based elastomer resin (product name “3400B” manufactured by JSR Corporation) was changed to 70 parts by mass, and 40 parts by mass of polypropylene-based resin (product name “Q100F” manufactured by SunAllomer Ltd.) was changed to 30 parts by mass of olefin-based elastomer (product name “XLT8677” manufactured by Dow Chemical Company, gel fraction 0.2% by mass).

### Example 18

A laminated foam sheet having non-foam layers on both surfaces of a foam layer was obtained in the same manner as in Example 7 except that 60 parts by mass of non-crosslinked olefin-based elastomer resin (product name “3400B” manufactured by JSR Corporation) was changed to 70 parts by mass, and 40 parts by mass of polypropylene-based resin (product name “Q100F” manufactured by SunAllomer Ltd.) was changed to 40 parts by mass of a styrene-based elastomer (product name “AR-885C” manufactured by Aron Kasei Co., Ltd., gel fraction 0.1% by mass).

For the obtained laminated foam sheet, the thickness of the foam layer, basis weight, density, closed cell ratio, melting point of the resin included in the foam layer, thickness of the non-foam layer, Duro A hardness, fracture point elongation percentage, melting point of the resin included in the non-foam layer, thickness of the entire laminated foam sheet, basis weight, density, maximum static friction coefficient, bending strength, and maximum displacement were measured. Furthermore, the thermoformability (1) and thermoformability (2) of the laminated foam sheet were evaluated. The obtained results are shown in Tables 3 and 4.

### <Thickness>

Excluding 20 mm at both ends in the width direction of the foam layer, non-foam layer, or laminated foam sheet, 21 points were set as measurement points at intervals of 50 mm in the width direction. At these measurement points, using a dial thickness gauge SM-12 (manufactured by Teclock), the thickness was measured up to a minimum unit of 0.01 mm. The average value of the measured values was set as the thickness T (mm).

### <Basis Weight>

Excluding 20 mm at both ends in the width direction of the foam layer or laminated foam sheet, 10 pieces of 10 cm×10 cm were cut out at equal intervals in the width direction, and the mass (g) of each piece was measured up to 0.001 g units. A value obtained by converting the average value of the mass (g) of each piece into the mass per 1 m² was set as the basis weight M (g/m²).

### <Density>

From the thickness T (mm) and the basis weight M (g/m²), the density p (Kg/m³) was determined using equation (2).

ρ=M/T (2)

### <Closed Cell Ratio>

The closed cell ratio was measured by the method described in JIS K7138: 2006 “Hard foamed plastics—How to determine open cell ratios and closed cell ratios”.

### <Melting Point>

The melting point of the resin used for the foam layer or the non-foam layer was measured by the method described in JIS K7121: 1987 “Method for Measuring Plastic Transition Temperature”.

### <Duro A Hardness>

The Duro A hardness was measured by the method described in JIS K6253-3 “Durometer Hardness of Vulcanized Rubber and Thermoplastic Rubber”.

The Duro A hardness was measured using GS-719N (manufactured by Teclock) as the measuring instrument.

### <Fracture Point Elongation Percentage>

The fracture point elongation percentage was measured by the method described in JIS K6251: 2010 “Vulcanized rubber and thermoplastic rubber—How to determine tensile properties”.

### <Maximum Static Friction Coefficient>

The maximum static friction coefficient was measured by JIS K7125 “Plastic, Film, and Sheet Friction Coefficient Test Method”.

Measuring apparatus: Tensilon universal testing machine RTG-1310 (manufactured by A & G)

Load cell: 100N, test speed 100 mm/min

Measured piece size: 40 cm² (63 mm side length), load: 1.96 N (200 g load) Counterpart material: The material was measured using a surface mirror-finished flat plate product with aluminum 5052 as a material.

### <Bending Strength>

Using a test piece cut into a size of width 50 mm×length 150 mm×thickness (thickness in each example), the bending strength in the MD direction and the TD direction was measured under the following conditions.

(Test Conditions)

Measuring apparatus: Tensilon universal testing machine RTG-1310 (manufactured by A & G).

n number: 3.

Test speed: 50 mm/min.

Distance between fulcrums: 100 mm.

Tip jig: Pressurized wedge 5R.

Support base: 2.5R.

The greater the bending strength, the better the strength.

### <Maximum Displacement>

The maximum displacement was measured by the same method as the bending strength and the amount of displacement at the maximum bending strength was measured.

The greater the maximum displacement, the harder it is for wrinkles to appear and the better the thermoformability.

### <Thermoformability (1)>

For a thermoforming, using a one-shot molding machine FVS-500 (manufactured by Wakisaka Engineering Co., Ltd.), a foam laminated thermoformed article having a diameter of 1554 and a depth of 60 mm at a heating temperature of 295° C. and a heating time of 22 seconds was obtained.

The obtained thermoformed article was left for 2 hours in an environment of 23±2° C. and humidity of 50±5% RH. After that, the surface of the thermoformed article was visually confirmed and the thermoformability was evaluated according to the following evaluation criteria.

### (Evaluation Criteria)

A: The surface is smooth, the container strength is sufficient, there is no peeling or the like, and the thermoformability is good.
B: The surface is smooth, the container strength is partially insufficient, and the thermoformability is poor.
C: There are irregularities on the surface, and also tears and the like.

### <Thermoformability (2)>

Using the laminated foam sheets obtained in Examples 1 to 18 and Comparative Examples 1 to 8, foam laminated thermoformed articles were produced in the same manner as thermoformability (1) except that the depth was changed.

The maximum depth at which it is possible to obtain a foam laminated thermoformed article having a smooth surface, sufficient container strength, no peeling or the like, and good thermoformability was determined.

TABLE I

| | | | | | | Non-foam layer | | | | | | | | |
|---|---|---|---|---|---|---|---|---|---|---|---|---|---|---|
| | Foam Layer | | | | | Compo- | | Compo- | | | | | Fracture | |
| | | | | Closed | | nent A | | nent B | | | | | point | |
| | Thick- | Basis | | cell | Melting | | Melting | | Melting | Ratio | | | elongation | Thick- |
| Item | ness | weight | Density | ratio | point | | point | | point | Compo- | Compo- | Duro A | percentage | ness |
| Unit | mm | g/m² | kg/m³ | % | ° C. | Resin | ° C. | Resin | ° C. | nent A | nent B | hardness | % | μm |
| Example 1 | 3.0 | 540 | 180 | 75 | 160 | 3400B | 120 | — | — | 100 | 0 | 33 | 1000 or | 150 |
| | | | | | | | | | | | | | more | |
| Example 2 | 3.0 | 450 | 150 | 75 | 160 | 3400B | 120 | — | — | 100 | 0 | 33 | 1000 or | 150 |
| | | | | | | | | | | | | | more | |
| Example 3 | 3.0 | 450 | 150 | 75 | 160 | 3400B | 120 | — | — | 100 | 0 | 33 | 1000 or | 300 |
| | | | | | | | | | | | | | more | |
| Example 4 | 3.0 | 450 | 150 | 75 | 160 | 3600B | 118 | — | — | 100 | 0 | 58 | 1030 | 150 |
| Example 5 | 3.0 | 450 | 150 | 75 | 160 | 3600B | 118 | — | — | 100 | 0 | 58 | 1030 | 300 |
| Example 6 | 3.0 | 450 | 150 | 75 | 160 | 3700B | 116 | — | — | 100 | 0 | 65 | 910 | 150 |
| Comparative | 3.0 | 450 | 150 | 75 | 160 | BC6C | 160 | — | — | 100 | 0 | 90 or | 500 | 95 |
| Example 1 | | | | | | | | | | | | more | | |
| Comparative | 3.0 | 450 | 150 | 75 | 160 | BC6C + | 160 | — | — | 100 | 0 | 90 or | 350 | 150 |
| Example 2 | | | | | | tiller | | | | | | more | | |
| Comparative | 3.0 | 540 | 180 | 75 | 160 | — | — | — | — | 0 | 0 | — | — | 0 |
| Example 3 | | | | | | | | | | | | | | |
| Comparative | 3.0 | 450 | 150 | 75 | 160 | 1301B | 120 | — | — | 100 | 0 | 37 | 660 | 150 |
| Example 4 | | | | | | | | | | | | | | |
| Comparative | 3.0 | 450 | 150 | 75 | 160 | 1703B | 120 | — | — | 100 | 0 | 73 | 730 | 150 |
| Example 5 | | | | | | | | | | | | | | |
| Comparative | 1.2 | 250 | 208 | 20 | 160 | 3400B | 120 | — | — | 100 | 0 | 33 | 1000 or | 150 |
| Example 6 | | | | | | | | | | | | | more | |
| Comparative | 3.0 | 450 | 150 | 75 | 160 | TR2000 | 100 | — | — | 100 | 0 | 90 or | 600 | 150 |
| Example 7 | | | | | | | | | | | | more | | |
| Comparative | 2.3 | 350 | 152 | 75 | 160 | 3400B | 120 | — | — | 100 | 0 | 33 | 1000 or | 150 |
| Example 8 | | | | | | | | | | | | | more | |

TABLE 2

| | Laminated foam sheet | | | | | | | | | |
|---|---|---|---|---|---|---|---|---|---|---|
| | | | | | | | Maximum | | | |
| | | Basis | | | Bending strength | | displacement | | Thermoformability | |
| Item | Thickness | weight | Density | Static Friction | MD | TD | MD | TD | | (2) |
| Unit | mm | g/m² | kg/m^{J} | Coefficient | MPa | MPa | mm | mm | (1) | mm |
| Example 1 | 3.3 | 840 | 255 | 3.36 | 3.7 | 3.2 | 15.4 | 15.6 | A | 80 |
| Example 2 | 3.3 | 750 | 227 | 3.74 | 3.2 | 2.9 | 16.6 | 16.1 | A | 80 |
| Example 3 | 3.6 | 1050 | 292 | 3.94 | 4 | 3.5 | 13.2 | 13.8 | A | 70 |
| Example 4 | 3.3 | 750 | 227 | 2.88 | 3.6 | 3.1 | 14.6 | 14.8 | B | 40 |
| Example 5 | 3.6 | 1050 | 292 | 3.07 | 4.2 | 3.7 | 12.5 | 12.6 | B | 40 |
| Example 6 | 3.3 | 750 | 227 | 2.35 | 4.8 | 4.5 | 11.0 | 10.5 | B | 20 |
| Comparative | 3.2 | 640 | 200 | 0.31 | 4.2 | 3.9 | 7.6 | 7.7 | A | 60 |
| Example 1 | | | | | | | | | | |
| Comparative | 3.3 | 750 | 227 | 0.31 | 7.2 | 7.1 | 6.6 | 6.7 | A | 60 |
| Example 2 | | | | | | | | | | |
| Comparative | 3.0 | 540 | 180 | 0.24 | 4.2 | 3.6 | 11.1 | 11.2 | A | 60 |
| Example 3 | | | | | | | | | | |
| Comparative | 3.3 | 750 | 227 | 0.64 | 4 | 3.5 | 7.5 | 7.1 | C | 0 |
| Example 4 | | | | | | | | | | |
| Comparative | 3.3 | 750 | 227 | 0.44 | 4.5 | 4 | 6.8 | 6.5 | C | 0 |
| Example 5 | | | | | | | | | | |
| Comparative | 1.5 | 550 | 367 | 3.85 | 1.9 | 1.7 | 11.9 | 11.8 | C | 0 |
| Example 6 | | | | | | | | | | |
| Comparative | — | — | — | — | — | — | — | — | C | 0 |
| Example 7 | | | | | | | | | | |
| Comparative | 2.6 | 650 | 250 | 3.67 | 3.5 | 3.2 | 10.4 | 9.7 | C | 0 |
| Example 8 | | | | | | | | | | |

TABLE 3

| | | | | | | Non-foam layer | | | | | | | | |
|---|---|---|---|---|---|---|---|---|---|---|---|---|---|---|
| | Foam Layer | | | | | Compo- | | Compo- | | | | | Fracture | |
| | | | | Closed | | nent A | | nent B | | | | | point | |
| | Thick- | Basis | | cell | Melting | | Melting | | Melting | Ratio | | | elongation | Thick- |
| Item | ness | weight | Density | ratio | point | | point | | point | Compo- | Compo- | Duro A | percentage | ness |
| Unit | mm | g/m² | kg/m³ | % | ° C. | Resin | ° C. | Resin | ° C. | nent A | nent B | hardness | % | μm |
| Exam- | 3.0 | 340 | 113 | 75 | 160 | 3400B | 120 | Q100F | 142 | 60 | 40 | 51 | 1000 or | 150 |
| ple 7 | | | | | | | | | | | | | more | |
| Exam- | 3.0 | 340 | 113 | 70 | 160 | 3400B | 120 | Q100F | 142 | 60 | 40 | 53 | 1000 or | 300 |
| ple 8 | | | | | | | | | | | | | more | |
| Exam- | 3.0 | 340 | 113 | 75 | 160 | 3400B | 120 | Q100F | 142 | 60 | 40 | 54 | 1000 or | 100 |
| ple 9 | | | | | | | | | | | | | more | |
| Exam- | 2.0 | 540 | 270 | 75 | 160 | 3400B | 120 | Q100F | 142 | 60 | 40 | 51 | 1000 or | 150 |
| ple 10 | | | | | | | | | | | | | more | |
| Exam- | 6.0 | 560 | 93 | 75 | 160 | 3400B | 120 | Q100F | 142 | 60 | 40 | 52 | 1000 or | 150 |
| ple 11 | | | | | | | | | | | | | more | |
| Exam- | 3.0 | 340 | 113 | 75 | 160 | 3400B | 120 | Q100F | 142 | 60 | 40 | 50 | 1000 or | One |
| ple 12 | | | | | | | | | | | | | more | surface |
| | | | | | | | | | | | | | | 150 |
| Exam- | 3.0 | 340 | 113 | 70 | 160 | 3400B | 120 | Q100F | 142 | 80 | 20 | 40 | 1000 or | 150 |
| ple 13 | | | | | | | | | | | | | more | |
| Exam- | 3.0 | 340 | 113 | 75 | 160 | 3400B | 120 | Q100F | 142 | 20 | 80 | 65 | 1000 or | 150 |
| ple 14 | | | | | | | | | | | | | more | |
| Exam- | 3.0 | 340 | 113 | 75 | 160 | 3700B | 116 | Q100F | 142 | 60 | 40 | 69 | 910 | 150 |
| ple 15 | | | | | | | | | | | | | | |
| Exam- | 3.0 | 340 | 113 | 75 | 160 | 3400B | 120 | Q300F | 162 | 60 | 40 | 62 | 1000 or | 150 |
| ple 16 | | | | | | | | | | | | | more | |
| Exam- | 3.0 | 340 | 113 | 75 | 160 | 3400B | 120 | XLT8677 | 150 | 70 | 30 | 55 | 1000 or | 150 |
| ple 17 | | | | | | | | | | | | | more | |
| Exam- | 3.0 | 340 | 113 | 75 | 160 | 3400B | 120 | AR-885 | 148 | 70 | 30 | 58 | 1000 or | 150 |
| ple 18 | | | | | | | | | | | | | more | |

TABLE 4

| | Laminated foam sheet | | | | | | | | | |
|---|---|---|---|---|---|---|---|---|---|---|
| | | | | | | | Maximum | | | |
| | | Basis | | | Bending strength | | displacement | | Thermoformability | |
| Item | Thickness | weight | Density | Static Friction | MD | TD | MD | TD | | (2) |
| Unit | mm | g/m² | kg/m^{J} | Coefficient | MPa | MPa | mm | mm | (1) | mm |
| Example 7 | 3.3 | 640 | 194 | 3.11 | 4.1 | 4.3 | 13.5 | 13.5 | A | 120 |
| Example 8 | 3.6 | 940 | 261 | 3.15 | 4.5 | 4.4 | 13.3 | 13.2 | A | 115 |
| Example 9 | 3.2 | 540 | 169 | 3.04 | 4 | 4.1 | 13.1 | 13.5 | A | 120 |
| Example 10 | 2.3 | 840 | 365 | 3.09 | 4.9 | 4.5 | 12.8 | 13.0 | A | 125 |
| Example 11 | 6.3 | 860 | 137 | 3.13 | 3.6 | 3.8 | 14.1 | 14.5 | A | 115 |
| Example 12 | 3.2 | 640 | 203 | 3.20 | 3 | 3.3 | 11.1 | 11.4 | A | 125 |
| Example 13 | 3.3 | 640 | 194 | 3.27 | 3.6 | 3.9 | 15.0 | 15.4 | A | 100 |
| Example 14 | 3.3 | 640 | 194 | 2.40 | 4.4 | 4.2 | 12.8 | 13.2 | A | 100 |
| Example 15 | 3.3 | 640 | 194 | 2.13 | 4.5 | 4.6 | 11.3 | 11.5 | A | 105 |
| Example 16 | 3.3 | 640 | 194 | 2.86 | 4.2 | 4.2 | 11.0 | 10.8 | A | 110 |
| Example 17 | 3.3 | 640 | 194 | 2.62 | 4.6 | 4.7 | 10.8 | 11.1 | A | 105 |
| Example 18 | 3.3 | 640 | 194 | 2.45 | 4.8 | 4.5 | 11.2 | 12.0 | A | 105 |

The laminated foam sheets of Examples 1 to 18 to which the present invention was applied had a slip-resistant surface, excellent strength, and excellent thermoformability.

Examples 7 to 18 including the resin (P) in the non-foam layer were particularly excellent in thermoformability.

In Comparative Examples 1 and 2 in which the non-foam layer did not include a non-crosslinked olefin-based elastomer, the maximum displacement was small and the surface was slippery.

The surface of Comparative Example 3 which did not have a non-foam layer was slippery.

Comparative Examples 4 and 5 using a dynamically cross-linked olefin-based elastomer instead of the non-crosslinked olefin-based elastomer were inferior in thermoformability.

Comparative Example 6 in which the thickness of the foam layer was 1.2 mm and the closed cell ratio was 20% was inferior in strength.

In Comparative Example 7 using a styrene-based elastomer instead of a non-crosslinked olefin-based elastomer, the foam layer and the non-foam layer did not obtain a sufficient adhesive strength and it was not possible to obtain a measurable laminated sheet.

In Comparative Example 8 in which the closed cell ratio of the foam layer was 25%, the foam layer was tom during thermoforming and it was not possible to obtain a molded article.

### INDUSTRIAL APPLICABILITY

According to the present invention, it is possible to provide a laminated foam sheet having a slip-resistant surface, excellent strength, and excellent thermoformability, and a molded article thereof.

### REFERENCE SIGNS LIST

1 . . . LAMINATED FOAM SHEET
10 . . . FOAM LAYER
20 . . . NON-FOAM LAYER
2 . . . CONTAINER.

1. A laminated foam sheet comprising:
a foam layer, and
a non-foam layer positioned on one surface or both surfaces of the foam layer,
wherein a closed cell ratio of the foam layer is 70% or more and a thickness is 2.0 to 6.0 mm, and
the non-foam layer includes a non-crosslinked olefin-based elastomer.

2. The laminated foam sheet according to claim 1,
wherein the non-foam layer has a Duro A hardness of 70 or less as determined in accordance with JIS K6253-3.

3. The laminated foam sheet according to claim 1,
wherein a fracture point elongation percentage of the non-foam layer determined in accordance with JIS K6251 is 900% or more.

4. The laminated foam sheet according to claim 1,
wherein the non-foam layer has a thickness of 0.1 to 0.3 mm.

5. The laminated foam sheet according to claim 1, having a density of 100 to 400 Kg/m³.

6. The laminated foam sheet according to claim 1,
wherein a bending strength determined in accordance with JIS K7171 is 6.0 MPa or less.

7. The laminated foam sheet according to claim 1,
wherein a maximum displacement determined in accordance with JIS K7171 is 10 mm or more.

8. The laminated foam sheet according to claim 1,
wherein a maximum static friction coefficient determined in accordance with JIS K7125 is 2.0 or more.

9. The laminated foam sheet according to claim 1,
wherein the foam layer includes a polypropylene-based resin.

10. The laminated foam sheet according to claim 1,
wherein the non-foam layer has a melting point of 140° C. or higher and includes a resin (P) other than the non-crosslinked olefin-based elastomer.

11. The laminated foam sheet according to claim 10,
wherein the resin (P) includes at least one type selected from the group consisting of a polypropylene-based resin and a thermoplastic elastomer.

12. The laminated foam sheet according to claim 10,
wherein, in the non-foam layer, a content of the resin (P) is 20 to 80% by mass with respect to 100% by mass of the resin forming the non-foam layer.

13. The laminated foam sheet according to claim 10,
wherein, in the non-foam layer, a mass ratio represented by (mass of the non-crosslinked olefin-based elastomer):(mass of the resin (P)) is 20:80 to 80:20.

14. The laminated foam sheet according to claim 1,
wherein, in the non-foam layer, a content of the non-crosslinked olefin-based elastomer is 20 to 80% by mass with respect to 100% by mass of the resin forming the non-foam layer.

15. A molded article formed by molding the laminated foam sheet according to claim 1.
